(19) United States
(12) Patent Application Publication
(10) Pub. No.: US 2005/0249892 A1
(43) Pub. Date: Nov. 10, 2005

(54) Self-shaping artificial tree

(76) Inventor: Peter O. Rocheleau, Brimfield, MA (US)

Correspondence Address: FISH & RICHARDSON PC, P.O. BOX 1022, MINNEAPOLIS, MN, 55440-1022, US

(21) Appl. No.: 10/911,331

(22) Filed: Aug. 4, 2004

(51) Int. Cl. A01N 3/00

(52) U.S. Cl. 428/18; 428/20

(57) ABSTRACT

An artificial tree structure including a center pole, a number of main branches each attached to the center pole and extending outward, and a number of branch tips each attached to one of the main branches at a predetermined orientation relative to the branch, there being a bias of the tips toward the predetermined orientation when the tips are deflected from the predetermined orientation.

### TECHNICAL FIELD

This description relates to artificial trees.

### BACKGROUND

Artificial trees have been provided in various forms and arrangement to simulate the appearance of a natural tree. Some trees include a center pole configured to receive multiple branches of suitable lengths to form a generally conical evergreen tree shape. Branch tips can extend from the main branches to give the tree a full and natural appearance. Such trees are often stored in compact form and require alignment and positioning of the main branches and branch tips to achieve the desired overall appearance for display purposes.

### SUMMARY

In general, in one aspect, the artificial tree features a center pole, a number of main branches attached to the center pole and extending outward, and a number of branch tips each attached to the main branches at a predetermined orientation relative to the branch, there being a bias of the tips toward the predetermined orientation when the tips are deflected from the predetermined position.

In various embodiments, the tree can include main branches which are positionable between a stowed state and a deployed state. The main branches can be configured to be biased toward the deployed state. The branch tips can also be positionable between a stowed state and a deployed state. The branch tips can be configured to be biased toward the deployed state.

In one example, the branch tips are substantially adjacent the main branches in the stowed state and the branch tips extended away from the main branches in the deployed state at an angle θ. In some embodiments, θ is between about 25 and about 45 degrees.

In preferred embodiments, the branch tips are formed from spring steel wire, such as for example, high-carbon steel. In other embodiments, the main branches are formed from spring steel wire, such as for example, high-carbon steel. In one example, the diameter of the branch tip wire is between about 0.03 mm (1.2 mils) and about 1.6 mm (63.0 mils). In a preferred embodiment, the diameter of the branch tip wire is between about 0.8 mm (31.5 mils) and about 1.2 mm (47.2 mils).

In various applications, the branch tips are attached to the main branches with a fiber wrapped around one end of each of the branch tips and the adjacent portion of one of the main branches. The main branches can be attached to the center pole with a fiber wrapped around one end of the main branch and the adjacent portion of the center pole.

In other examples, the main branches are rotatably attached to the center pole at a hinge assembly, for example. In another example, the main branches include a hook extending from one end and the center pole includes a coupler configured for receiving the hook of the main branches.

In one example, the tree includes a number of light fixtures permanently attached to the branch tips and main branches along uniform intervals. In another example, the tree includes a light source and a fiber-optic wire extending from the light source to one or various locations on the main branches and branch tips. The branch tips can also include needles in a variety of styles including for example, bristle, cone tip, round tip, pointed tip, Canadian tip or any combination thereof. In some examples, the tree needles are between about 2.54 cm (1 inch) and about 25.4 cm (10 inches) in width and are made from polyvinyl-chloride (PVC) or polyethylene.

In one example, the center pole of the tree includes one or more sections for releasable attachment to each other. In this configuration, the tree can also include one or more containers, such as reclosable bags, which are sized and configured for storing the sections of the center pole when the main branches and the branch tips are in the stowed position.

In another aspect, an artificial tree structure includes a substantially vertical center pole including a base, a curved element extending from a top portion of the pole to a bottom portion of the base, a number of main branches attached to the element and extending outward. A number of branch tips are attached along the main branches at a predetermined orientation and configured to bias toward the predetermined orientation when deflected.

In another aspect, an artificial tree structure includes a substantially vertical center pole; a number of main branches attached to the center pole and extending radially outward therefrom, the branches being positionable between a stowed state and a deployed state, and biased toward the deployed state, and a number of branch tips positionable between a stowed state and a deployed state and biased toward the deployed state, each branch tips being attached to one of the main branches at a predetermined orientation relative to the branch, there being a bias of the tips toward the predetermined orientation when the tips are deflected from the predetermined orientation. The branch tips are substantially adjacent the main branches in the stowed state and the branch tips are extended away from the main branches at an angle between about 25 and about 45 degrees in the deployed state.

In another aspect, a method of assembling an artificial tree stored within a container includes removing the tree from the container, releasing main branches attached to a center pole from a stowed state to permit automatic movement of the main branches toward a predetermined orientation relative to the center pole, and releasing the branch tips attached to one of the main branches from a stowed state to permit automatic movement of the branch tips toward a predetermined orientation relative to the main branches.

In another aspect, a method of disassembling an artificial tree includes providing the artificial tree as described in any of the foregoing aspects; deflecting the branch tips toward an orientation substantially adjacent the main branches against the bias toward the predetermined orientation, deflecting the main branches toward an orientation substantially adjacent the center pole, and then, sliding the tree into storage container. In one example, the method also includes separating the center pole of the tree into two or more sections, and placing each section into a separate container sized and configured for storing each section.

Other advantages and features will become apparent from the description and the claims.

### DESCRIPTION

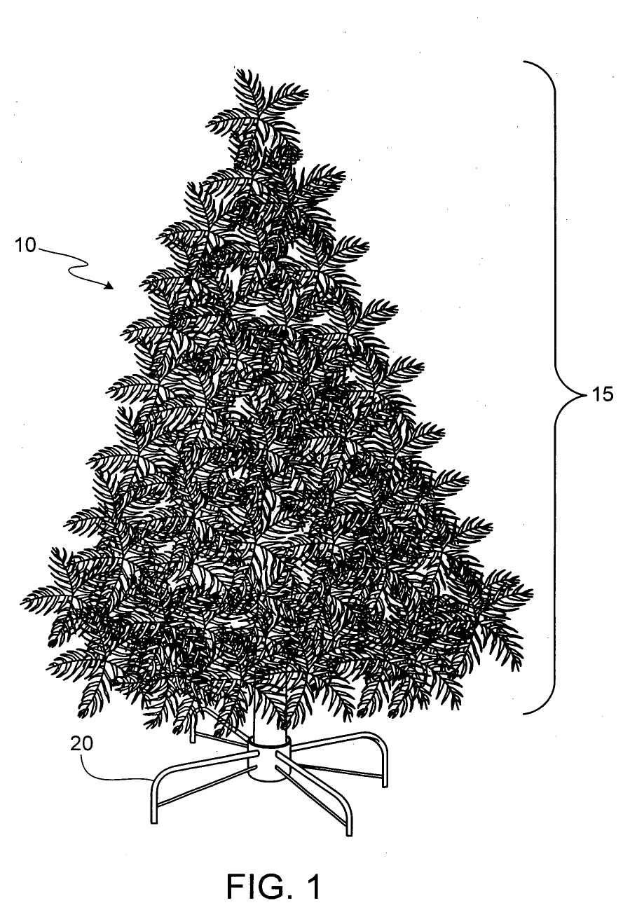

FIG. 1 is a front view of an artificial tree.

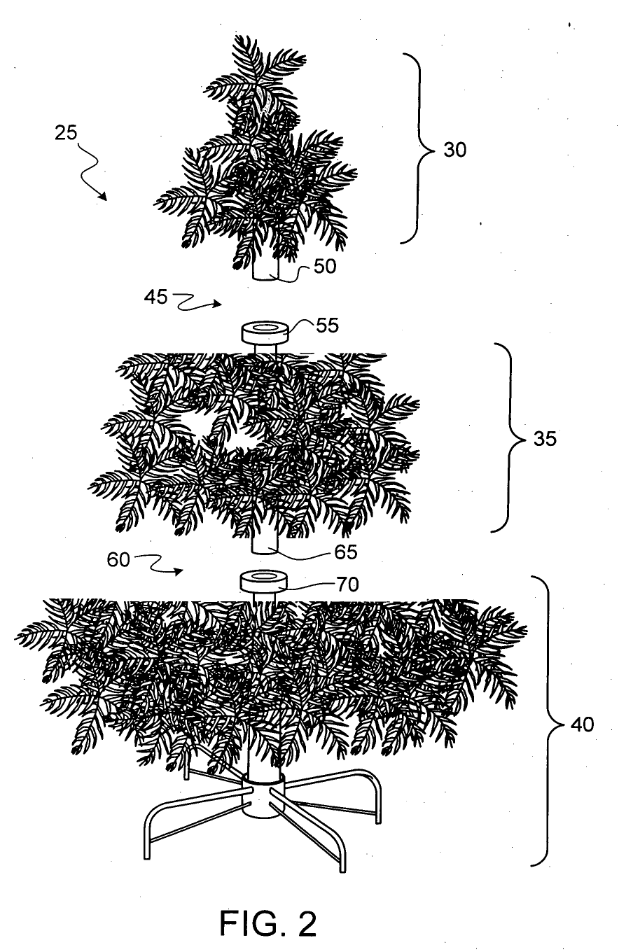

FIG. 2 is a front view of an artificial tree having multiple attachable sections.

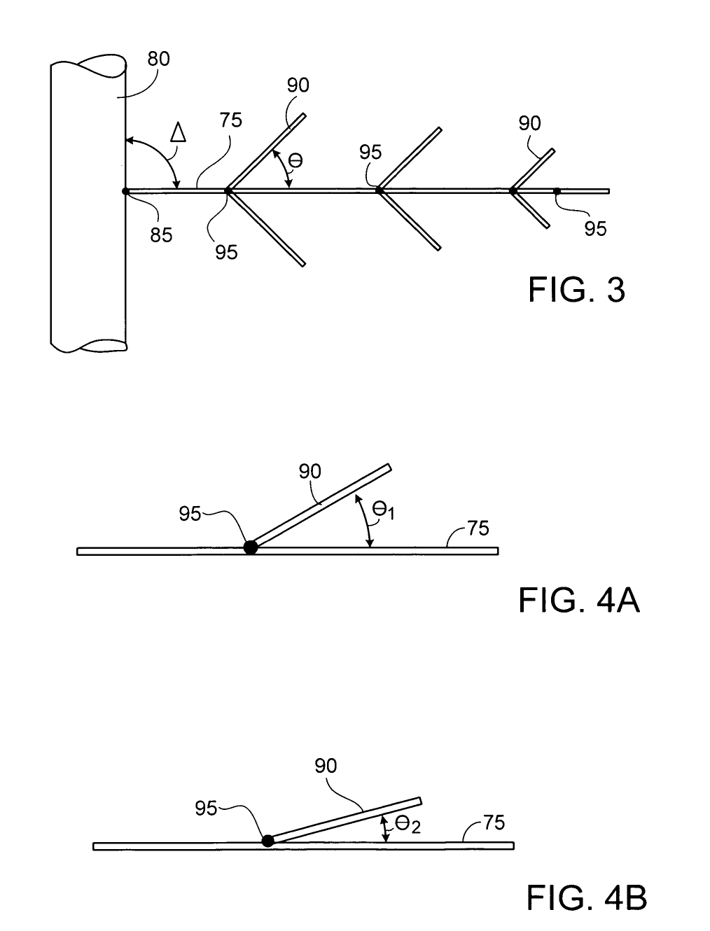

FIG. 3 is a schematic view of main branch including a number of branch tips extending therefrom.

FIGS. 4A and 4B are detail views of the junction between a main branch and the branch tips in a deployed and stored position, respectively.

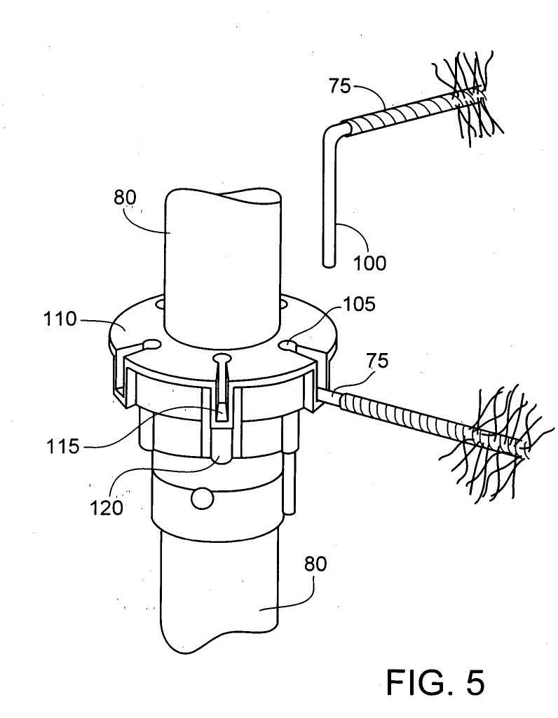

FIG. 5 is a detail view of a hooked junction between the main branch and the center pole of an artificial tree.

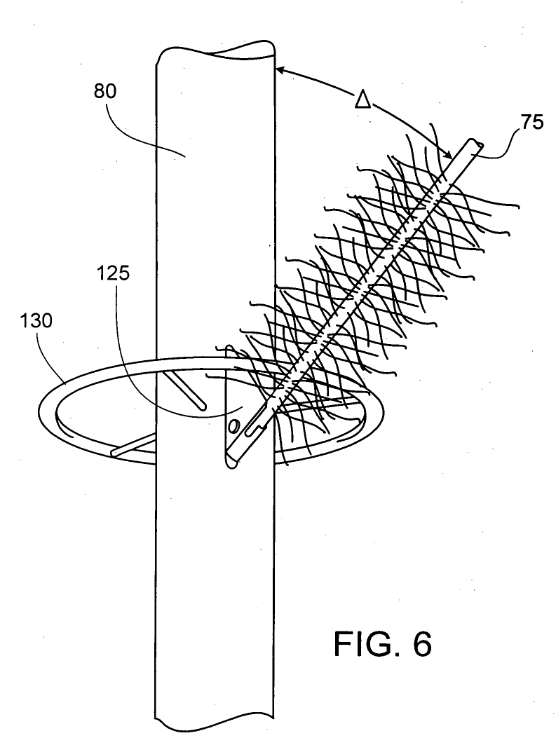

FIG. 6 is a detail view of hinged junction between the main branch and the center pole of an artificial tree.

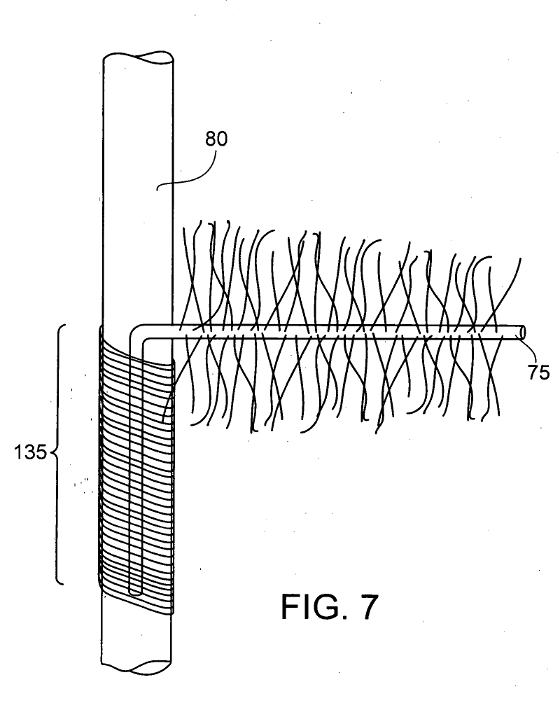

FIG. 7 is a detail view of a wrapped junction between the main branch and the center pole of an artificial tree.

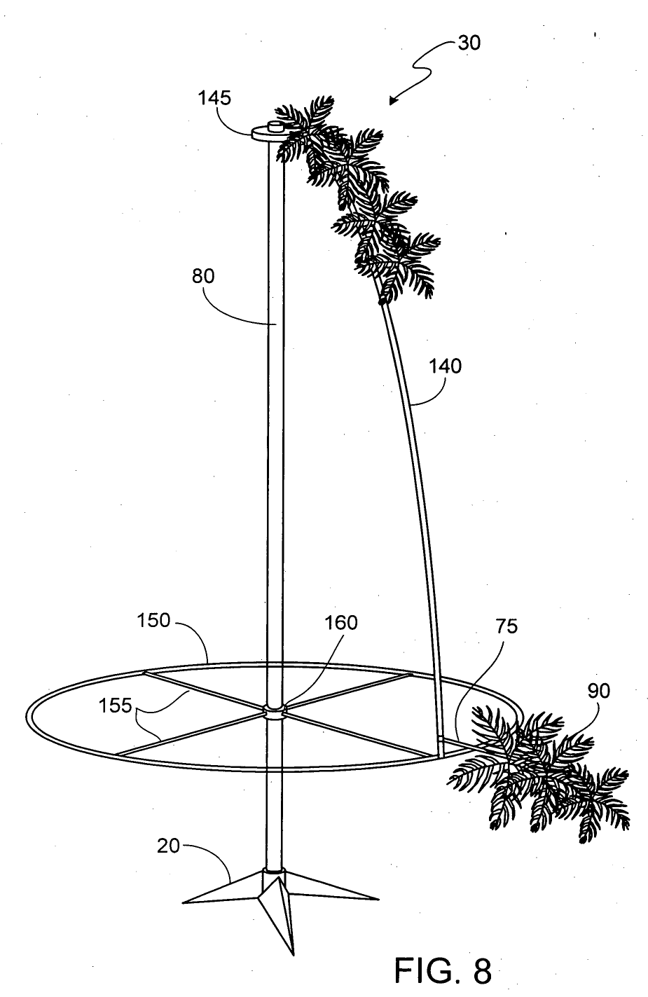

FIG. 8 is a front view of a partially assembled artificial tree where the main branches are attached to substantially vertical rib supports.

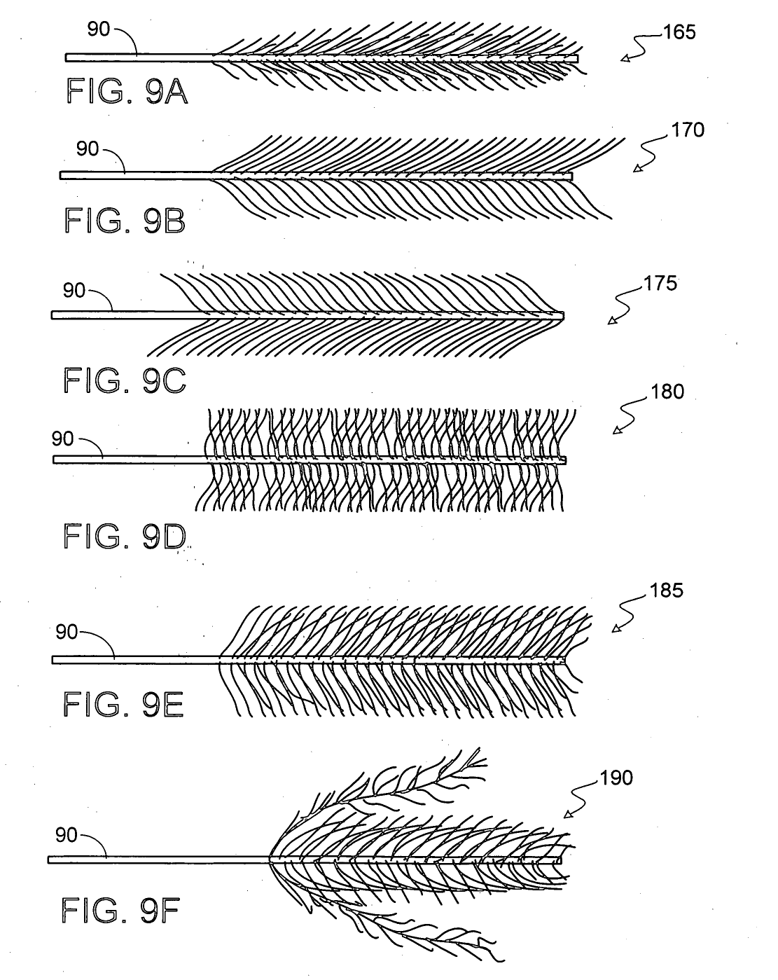

FIGS. 9A to 9F are views of various styles of branch tips.

Like reference symbols in the various drawings indicate like elements.

Referring to FIG. 1, an artificial tree 10 includes a main body 15 supported by a base 20. The main body of the tree includes a number of main branches of suitable lengths attached to a center pole to simulate the appearance of a natural tree. In some embodiments, the tree 10 can be between about 0.3048 m (1 ft) and about 3.66 m (12 feet) in height. The center pole can be made from any dimensional stable material, such as metal, wood or plastic, for example. FIG. 2 depicts a multi-section artificial tree 25 which is formed by upper, middle and lower tree sections, 30, 35, and 40, respectively. The upper and middle sections 30, 35 are releasbly connected at an upper collar 45, the upper collar including an engageable post 50 and sleeve 55. The middle and lower sections 35, 40 are releasbly connected at a lower collar 60, the lower collar including an engageable post 65 and sleeve 70.

Referring now to FIG. 3, a main branch 75 of the main body 15 (FIG. 1) is shown schematically attached to a center pole 80 at a junction 85 (branch needles are removed for clarity). The main branch defines an angle Δ from the center pole 80. In some embodiments, Δ can range from between about 0 to 90 degrees. A branch tips 90 can be attached along the main branch 80 at a junction 95. The branch tips 90 are sized, configured and attached along the main branch to simulate a natural tree branch. Referring also to FIGS. 4A and 4B, the branch tips 90 define an angle θ from the main branch 75. In some embodiments, θ can range from about 0 to 90 degrees, in some preferred embodiments, θ can range from about 25 to about 45 degrees. FIG. 4A depicts the main branch 75 in a deployed position θ₁ in which the branch tips are positioned such that θ is about 45 degrees. FIG. 4B depicts the main branch 75 is a stowed position θ₂ in which the branch tips are positioned such that θ is about 10 degrees.

In one embodiment, the branch tips 90 are formed from spring steel, such as, but not limited to a high-carbon steel for example, and configured to maintain a predetermined angle θ₁ from the main branch 75 when deflected. In some embodiments, the diameter of the branch tip 90 wire is between about 0.03 mm (1.2 mils) and about 1.6 mm (63.0 mils). In preferred embodiments, the diameter of the branch tip 90 wire is between about 0.8 mm (31.5 mils) to about 1.2 mm (47.2 mils). The diameter of the branch tip wire should be large enough to provide for restorative movement to a predetermined position when deflected but not large enough to so minimize deflection of the branches that the appearance of the tree is unnatural. When storage or shipping of the tree 10 is required, the branch tips 90 can be pressed toward the main branch 75 for reduction of the volumetric size of each main branch and accordingly, the overall size of the tree 10. The tree can be then be placed in a storage contained such as a suitable box or bag to retain the position of branch tips 90 in the stowed position as shown in FIG. 4B. For the multi-section artificial tree of FIG. 2, separate containers sized and configured for each of the upper, middle and lower tree sections can be provided. The branch tips 90 can be elastically deflected for storage but return to the substantially deployed position shown in FIG. 4A when no longer deflected.

The branch tips 90 are biased toward the properly aligned deployed position to reduce or eliminate the need for manually positioning each branch tip for the desired appearance. Manually shaping the tree branch tips can require considerable amounts of time and at least a modicum of skill to obtain the desired overall appearance of the tree. Accordingly, an artificial tree may not be shaped properly for retail or consumer display.

In one embodiment, the main branch 75 is also formed from spring steel, such as, but not limited to a high-carbon steel for example, and configured to maintain a predetermined angle Δ₁ from the center pole 80 when deflected.

As with the branch tips 90, when storage or shipping of the tree 10 is required, the main branches 75 can be pressed toward the center pole 80 for reducing the overall size of the tree 10. The tree can be then be placed in a storage contained such as a suitable box or bag to retain the position of branch tips 75 in the stowed position. For the multi-section artificial tree of FIG. 2, separate containers sized and configured for each of the upper, middle and lower tree sections can be provided. The main branches 75 permit elastic deflection for storage but return to the substantially deployed position shown in FIG. 4A when no longer deflected. Other embodiments are shown in FIGS. 5, 6 and 7.

Referring to FIG. 5, the main branch 75 can include a hook 100 at one end which is sized and configured for insertion into a slot 105 of a coupler 110. The coupler 110 includes a bore through which the center pole 80 extends. The slots 105 can be arranged about the coupler 110 at regular intervals and include an open portion 115 and a closed portion 120. After the hook 100 of the main branch 75 is positioned within the open portion 115, the main branch can be pushed downward to releasable attach the hook 100 within the closed portion 120.

Referring to FIG. 6, the main branch 75 can be rotatably attached to the center pole 80 at a hinge assembly 125. In one example, a position ring 130 is located along the center pole 80 proximate to the hinge assembly 125. The main branch 75 can be rotated upward about the hinge assembly 125 from the deployed position shown in FIG. 6 to a stowed position wherein the main branch is substantially adjacent to the center pole 80 (not shown). The position ring 130 engages a portion of the hinge assembly 125 to limit rotation of the main branch 75 at the desired angle Δ from the center pole 80.

Referring to FIG. 7, the main branch 75 can be attach to the center pole 80 by winding a wrap 135 about a hook 100 of the main branch 75 and a portion of the center pole which is adjacent thereto. In this configuration, the main branch 75 the main branch is formed from spring steel, such as, but not limited to a high-carbon steel for example, and configured to maintain a predetermined angle Δ from the center pole 80 when deflected.

Referring to FIG. 8, the artificial tree 30 can include what is known as a “panel” design. In this example, the main branches 75 of varying lengths are attached along the span of a number of rib supports 140. The rib supports 140 extend from an upper hub 145 positioned at the top of the center pole 80 to a large ring support 150 positioned proximate on the center pole 80 proximate the base 30. The ring support 150 is secured to the center pole by a number of spokes 155 radially extending from a lower hub 160 which is secured to the center pole 80.

In some examples, the needles extending from the main branches 75 and branch tips 90 as shown in FIGS. 1, 2, 6, 7 and 8 can be formed from polyvinyl-chloride (PVC) or polyethylene and can vary in width from between about 2.54 cm (1 inch) and 25.4 cm (10 inches). In one example, needle construction can be between 2-ply and 4-ply. FIGS. 9A to 9F depict needles configured the branch tips 90 in varying tip styles. For example, FIG. 9A shows a round tip style 165, FIG. 9B shows a coned tip style 170, FIG. 9C shows a pointed tip style 175, FIG. 9D shows a Canadian tip style 180, FIG. 9E shows a bristle-tip style 185 and FIG. 9E shows a mixed-tip style 190.

A number of embodiments of the invention have been described. Nevertheless, it will be understood that various modifications can be made without departing from the spirit and scope of the invention. For example, the tree 10 can manufactured to include a number of light fixtures permanently attached to the main branches 75 and branch tips 80 along uniform intervals (not shown). Alternatively, the tree 10 can include a unitary light source and a number of fiber-optic wires extending from the light source to suitable locations on the main branches 75 and branch tips 80 to uniformly illuminate the tree (not shown). Accordingly, other embodiments are within the scope of the following claims.

1. An artificial tree comprising:
a center pole;
a number of main branches each attached to the center pole and extending outward; and
a number of branch tips each attached to one of the main branches at a predetermined orientation relative to the branch, there being a bias of the tips toward the predetermined orientation when the tips are deflected from the predetermined orientation.

2. The tree of claim 1 wherein the main branches are positionable between a stowed state and a deployed state and biased toward the deployed state.

3. The tree of claim 1 wherein the branch tips are positionable between a stowed state and a deployed state and biased toward the deployed state.

4. The tree of claim 3 wherein the branch tips are substantially adjacent the main branches in the stowed state and the branch tips are extended away from the main branches at an angle θ in the deployed state.

5. The tree of claim 4 wherein θ is between about 25 and about 45 degrees.

6. The tree of claim 1 wherein the branch tips comprise spring steel.

7. The tree of claim 1 wherein the branch tips comprise high-carbon steel.

8. The tree of claim 1 wherein the branch tips comprise a wire having a diameter between about 0.03 mm (1.2 mils) and about 1.6 mm (63.0 mils).

9. The tree of claim 1 wherein the branch tips comprise a wire having a diameter between about 0.8 mm (31.5 mils) and 1.2 mm (47.2 mils).

10. The tree of claim 1 further comprising a fiber wrapped around one end of each of the branch tips and the adjacent portion of one of the main branches for attachment thereto.

11. The tree of claim 1 further comprising a fiber wrapped around one end of the main branch and the adjacent portion of the center pole for attachment thereto.

12. The tree of claim 1 wherein the main branches comprise spring steel.

13. The tree of claim 1 wherein the main branches comprise high-carbon steel.

14. The tree of claim 1 wherein the main branches are rotatably attached to the center pole.

15. The tree of claim 1 wherein each of the main branches further comprises a hook extending from one end and the center pole further comprises a fitting configured for receiving the hook of the main branch.

16. The tree of claim 1 further comprising a number of light fixtures permanently attached to the branch tips at uniform intervals.

17. The tree of claim 1 further comprising a light source and a fiber-optic wire extending from the light source to one or more branch tips.

18. The tree of claim 1 wherein the branch tips further comprise needles.

19. The tree of claim 18 wherein the needles are between about 2.54 cm (1 inch) and about 25.4 cm (10 inches) in width.

20. The tree of claim 18 wherein the needles comprise polyvinyl-chloride PVC).

21. The tree of claim 18 wherein the needles comprise polyethylene.

22. The tree of claim 2 wherein the center pole comprises one or more sections, the sections being releaseably attachable to each other.

23. The tree of claim 22 further comprising one or more containers sized and configured for storing the sections of the center pole when the main branches are in the stowed position.

24. An artificial tree structure comprising:
a substantially vertical center pole including a base;
a curved element extending from a top portion of the pole to the base;
a number of main branches attached to the element and extending outward; and
a number of branch tips attached to main branches at a predetermined orientation therefrom, wherein the tips are configured to bias toward the predetermined orientation when deflected.

25. An artificial tree structure comprising:
a center pole;
a number of main branches attached to the center pole and extending outward therefrom, the branches being positionable between a stowed state and a deployed state, and biased toward the deployed state; and
a number of branch tips positionable between a stowed state and a deployed state and biased toward the deployed state, each branch tips being attached to one of the main branches at a predetermined orientation relative to the branch, there being a bias of the tips toward the predetermined orientation when the tips are deflected from the predetermined orientation;
wherein the branch tips are substantially adjacent the main branches in the stowed state and the branch tips are extended away from the main branches at an angle between about 25 and about 45 degrees in the deployed state.

26. A method of assembling an artificial tree stored within a container, comprising:
removing the tree from the container;
releasing main branches attached to a center pole from a stowed state to permit automatic movement of the main branches toward a predetermined orientation relative to the center pole; and
releasing the branch tips attached to one of the main branches from a stowed state to permit automatic movement of the branch tips toward a predetermined orientation relative to the main branches.

27. A method of disassembling an artificial tree, comprising:
providing the artificial tree of claim 1;
deflecting the branch tips toward an orientation substantially adjacent the main branches against the bias toward the predetermined orientation;
deflecting the main branches toward an orientation substantially adjacent the center pole; and
thereafter, sliding the tree into storage container.

28. The method of claim 27 further comprising separating the center pole of the tree into two or more sections, and placing each section into a separate container sized and configured for storing each section.
